(19) United States
(12) Patent Application Publication
(10) Pub. No.: US 2007/0009069 A1
(43) Pub. Date: Jan. 11, 2007

(54) Method operable to determine a signal to noise ratio gap between selection combining and maximal ratio combining for an arbitrary number of diversity branches

(76) Inventors: Ning Kong, La Jolla, CA (US); Michiel Petrus Lotter, San Diego, CA (US)

Correspondence Address: GARLICK HARRISON & MARKISON, P.O. BOX 160727, AUSTIN, TX, 78716-0727, US

(21) Appl. No.: 11/205,888

(22) Filed: Aug. 17, 2005

Related U.S. Application Data
(60) Provisional application No. 60/696,875, filed on Jul. 6, 2005.

(51) Int. Cl. H04L 1/02

(52) U.S. Cl. 375/347

(57) ABSTRACT

The present invention provides a method of quantifying a signal to noise ratio (SNR) gap between diversity combining schemes that are operable to process multi-path wireless communications for an arbitrary number of diversity branches. The method determines the gap in a without the need to determine or know the SNR for each individual diversity combining scheme. This involves determining the number of diversity branches associated with the multi-path wireless communication and the receiver used to process the multi-path wireless communication. The SNR gap may then be expressed as the term 10log₁₀L!/L where L is the number of diversity branches.

### CROSS REFERENCE TO RELATED APPLICATIONS

This application claims the benefit of priority to and incorporates herein by reference in its entirety for all purposes, U.S. Provisional Patent Application No. 60/696,875 entitled “METHOD OPERABLE TO DETERMINE A SIGNAL TO NOISE RATIO GAP FOR A CERTAIN BIT ERROR RATE BETWEEN SELECTION COMBINING AND MAXIMAL RATIO COMBINING,” by Ning Kong, et al. filed on Jul. 6, 2005.

### TECHNICAL FIELD OF THE INVENTION

The present invention relates generally to diversity combining schemes, and more particularly, it provides a system and method for determining a signal to noise ratio (SNR) gap between selection combining (SC) and maximal ratio combining (MRC), wherein this SNR gap may be used to determine how to design communication systems which address multipath fading or other situations (not necessarily involves fading) where diversity combining is employed in order to enhance system performance.

### BACKGROUND OF THE INVENTION

Communication systems are known to support wireless and wire lined communications between wireless and/or wire lined communication devices. Such communication systems range from national and/or international cellular telephone systems, to the Internet, and to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

Direct or indirect communications may experience multipath fading. Multipath fading is the deflection of a wireless communications signals off obstacles that can cause interference during reception. Multipath fading occurs when a wireless communications signal is received by an antenna and later the same signal is received again, reflected from an obstacle. This can result from both retransmission and different transmission paths. Under certain conditions, two or more of the signals can interfere with each other and create “fading” (a loss of signal) in the communications link. Fading may occur when signals are retransmitted or received by multiple antennas. Thus, multipath fading may be observed within both wireless and wire-line communications. As the amount of data contained within wireless and wire-line communications increase and the power of the transmitted signal is reduced, the techniques chosen to combat the multipath fading can vary.

Communication systems (either wireless or wire line) may experience numerous impairments. Two main impairments are noise encountered and signal attenuation as the communication signal propagates through a transmission medium. An example of noise encountered can be thermal noise from communication equipments and an example of signal attenuation can be a cellular wireless communication system where fading due to shadowing, distance loss, and moving surroundings can completely destroy the desired signal. The most effect way to combat these two impairments is to use diversity methods. Diversity methods utilize the random nature of the noise and signal attenuation and create multiple independent signal copies to enhance the received signal quality by combining these copies which also are called diversity branches.

The two most popularly used combining schemes are maximal ratio combining (MRC), where all the diversity branches are selected and properly combined, and selection combining (SC) where only the strongest diversity branch is selected. The results of these combining schemes are embedded in almost all wireless and wire line (e.g., cable modems) standards, from the oldest first generation (1G) wireless (Amps) to 2G (GSM), to 3G (CDMA), also including the recent popular techniques from orthogonal frequency division modulation (OFDM) to multiple inputs and multiple outputs (MIMO). Due to the presence of MRC and SC within most mobile communication standards and equipment extensive and intensive studies on the properties of these two schemes have been undertaken. Both result in the same diversity gain when each has the same number of diversity branches. Since MRC involves more complexity when compared to SC and utilizes all diversity branches, MRC may result in better performance when compared with SC. This improved performance derives from an SNR gain that MRC provides over SC. To date, this gap has been at best approximated 10log₁₀L. This estimate is not accurate especially when L (the number of diversity branches) is not large.

Direct knowledge of the gap may help designers better assess whole system performance and allow system designers to design systems that can trade-off between complexity (and cost) and quality. Thus the lack of direct knowledge of the SNR gap forces the SNR gap between the MRC and SC to be estimated. Inaccuracies associated with this estimation can result is reduced communication performance.

Thus, there exists a need for the ability to accurately determine the SNR gain that MRC provides over SC. Additionally, there exists a need for the ability to efficiently select which diversity scheme to utilize in order to meet whole system requirements while minimizing system complexity.

### SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1A is a plot of how approximations of the MRC combining scheme approximate the actual expressions;

FIG. 1B is a plot of how approximations of the SC combining scheme approximate the actual expressions;

FIG. 2 is a plot of the SNR gain of MRC over SC as a function of the number of diversity branches;

FIG. 3 is a plots of the BERs of both MRC and SC from their actual BER expressions as a function of number of diversity branches as the number of diversity branches vary;

FIG. 4 is a schematic block diagram illustrating a communication system supported by embodiments of the present invention;

FIG. 5 is a schematic block diagram illustrating a wireless communication device supported by embodiments of the present invention;

FIG. 6 is a schematic block diagram illustrating one application of diversity combining within a RAKE receiver; and

FIG. 7 a logic flow diagram that provides a method for quantifying an SNR gap for a given bit error rate for two diversity combining schemes in accordance with an embodiment of the present invention.

### DETAILED DESCRIPTION OF THE INVENTION

Preferred embodiments of the present invention are illustrated in the FIGS., like numerals being used to refer to like and corresponding parts of the various drawings.

The use of diversity techniques is considered the most effective way to combat multipath fading in wireless mobile communications or other like environments. Diversity techniques improve the performance, e.g., bit error rate (BER) from inversely proportional to the signal-to-noise ratio (SNR) caused by fading to inversely proportional to the SNR raised to its L^{th} power, where L is the number of diversity branches, without increasing transmit power or sacrificing BW efficiency. Selection combining (SC) and maximal ratio combining (MRC) are the most popular diversity schemes and have been adopted into every cellular standard. However, other combining schemes are known to those having skill in the art. The performance of SC and MRC, in terms of BER or SNR has been well studied. It is known that, MRC performs better than SC, even though they both have the same diversity gain of an order equal to L. The performance difference comes from a SNR gain of MRC over SC. In other words, the slopes of the performances (logarithm of the BER vs. the SNR) of MRC and SC are the same, while the actual curve of SC is a certain shift of MRC to its right.

The present invention enables communication engineers and communication system designers to accurately determine the SNR gap between maximal ratio combining (MRC) scheme, where all the diversity branches are selected and properly combined, and the selection combining (SC) scheme where only the strongest diversity branch is selected. Both combining schemes result in the same diversity gain when each has the same number of diversity branches. Since MRC involves more complexity when compared to SC and utilizes all diversity branches, MRC may result in better performance when compared with SC. This improved performance derives from an SNR gain that MRC provides over SC. Knowing this gain allows engineers to assess whole system performance. Additionally, system designers can design systems that can trade-off between complexity (and cost) and quality. As previously stated, this gap was at best an approximation. The SNR gap between the MRC and SC has often and inaccurately been approximated as 10log₁₀L, where L is the number of diversity branches. In actuality, the term 10log₁₀L!/L more accurately describes this SNR gap. This new term corrects for many previously approximated inaccuracies when L is not large.

The first part of this applications discussion will focus on how a more accurate expression for the SNR gap may be derived. Next, the application will present potential presents situations where a more accurate understanding of the SNR gap may be applied.

To derive a more accurate term for the SNR gap, first expressions are approximated for the bit error rate (BER) of both MRC and SC with their main (dominate) parts. That is to say, the actual BER is comprised of terms which are the inverse of SNR raised to the L^{th} and higher orders; the approximation has only the term which is the inverse of SNR raised to the L^{th} order. The actual BER and its approximation are asymptotically the same as the SNR increases. Since the approximations of both MRC and SC are functions of its inverse of the SNR to the L^{th} order, by equating the two BERs, the SNR gap is obtained analytically after some mathematical manipulations. From this analysis is found that this gap monotonically increases in L increases.

One may derive an approximation of BER for SC as a function of L. The existing BER of MRC and its main part approximation may be examined first. The actual BER of MRC when the diversity branches are independently and identically distributed is given by the following expression:

$${Pe}_{MRC} = {( 1 - \frac{1}{\sqrt{1 + c}} )}^{L} {\sum }_{i = 0}^{L - 1} ( \begin{matrix}L - 1 + i \\ i\end{matrix} ) {( 1 + \frac{1}{\sqrt{1 + c}} )}^{i}$$

where

$$c = \frac{1}{Γ} ,$$

and Γ is the average SNR per diversity branch. This expression also presents an approximation with only c to its L^{th} order terms, for Γ>>1 (greater than 10 dB). i.e.:

$${Pe}_{mrc} \approx ( \begin{matrix}2 L - 1 \\ L\end{matrix} ) {( \frac{1}{4} c )}^{L} .$$

The actual BER of SC is:

$${Pe}_{sc} = \frac{1}{2} {\sum }_{i = 0}^{L} ( \begin{matrix}L \\ i\end{matrix} ) {( - 1 )}^{i} \frac{1}{\sqrt{1 + ic}}$$

When Γ>>1, one can prove that actual BER of SC can be approximated by its L^{th} order terms as the following:

$${Pe}_{sc} \approx \frac{( 2 L - 1 ) !!}{{2}^{L + 1}} {c}^{L} .$$

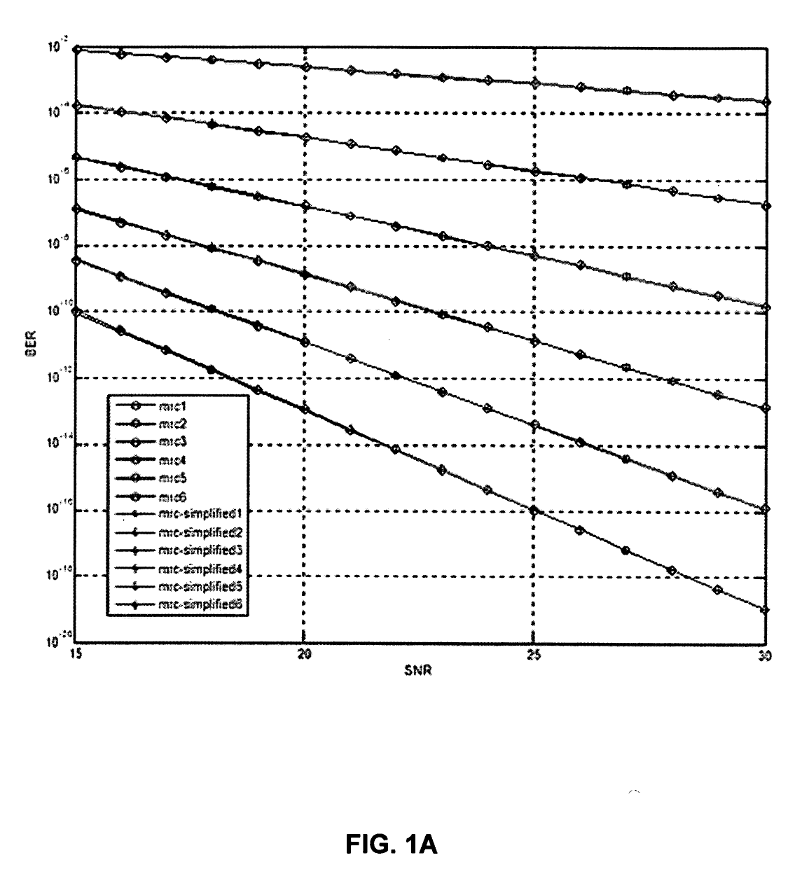

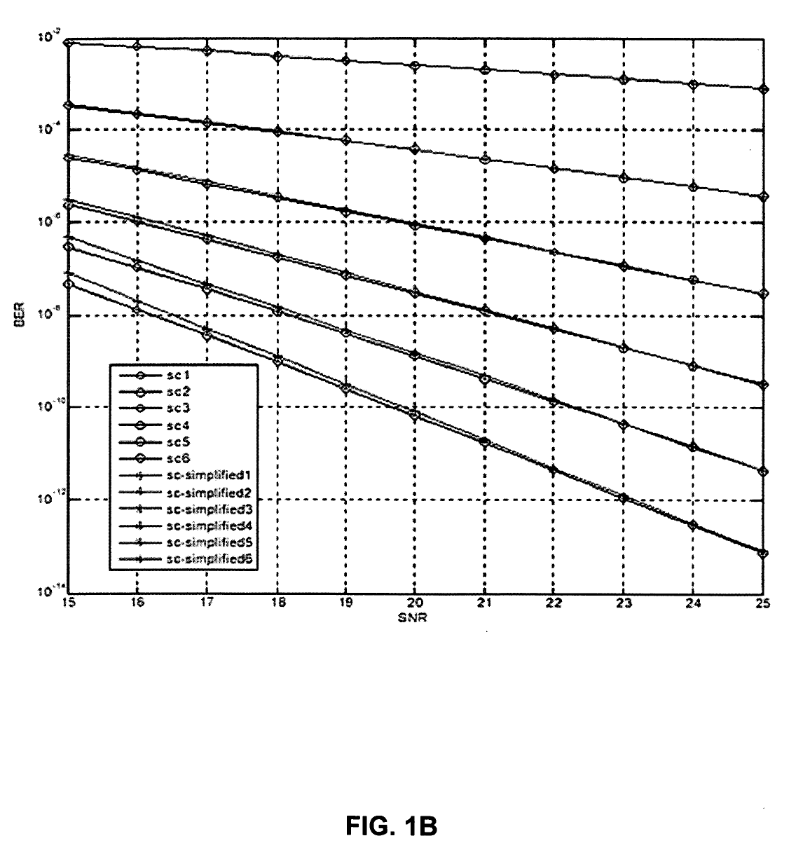

FIGS. 1A and 1B show how close these approximations are to their actual expressions. The actual BER expression of MRC as shown and its approximation are shown in FIG. 1A. FIG. 1B plots the actual BER expression of SC and its approximation. In both the FIGS., six pairs of BERs with L varying from one to six are plotted; each pair consists of two BERs, one from the actual and the other one from the approximation for that same L. In both FIGS. One can see that the pairs are more tightly overlapped as the SNR increases due to the fact that the BER approximations of both MRC and SC becomes more accurate as the SNR increases as explained previously. Also, one can observe that the approximation of the BER for MRC is closer to its actual BER as shown in FIG. 1A, than the approximation of the BER for SC to its actual BER as shown in FIG. 1B for the low-end SNRs and the difference is larger when L increases. The reason for this is that the convergence for MRC requires c<<1. While the convergence for SC requires Lc<<1. For the same c, due to the fact that Lc>c, the convergence for MRC can be quicker than that for SC depending on how large L is. However, that difference is very small and quickly disappears as SNR increases.

The following provides a derivation of the SNR difference between SC and MRC for an arbitrary L. One can rewrite the approximation for MRC as the following expression:

$${Pe}_{MRC} \approx ( \begin{matrix}2 L - 1 \\ L\end{matrix} ) {( \frac{1}{4} c )}^{L} = {( {( \begin{matrix}2 L - 1 \\ L\end{matrix} )}^{1 / L} \frac{1}{4} c )}^{L}$$

and the approximation for SC in a similar fashion:

$${Pe}_{SC} \approx \frac{( 2 L - 1 ) !!}{{2}^{L + 1}} {c}^{L} = {( {( \frac{( 2 L - 1 ) !!}{2} )}^{1 / L} \frac{1}{2} c )}^{L} .$$

These expressions may be equated with a change of variable:

$${( \begin{matrix}2 L - 1 \\ L\end{matrix} )}^{1 / L} \frac{1}{4} c = {c}_{1} , then c = 4 {{c}_{1} ( \begin{matrix}2 L - 1 \\ L\end{matrix} )}^{- 1 / L} .$$

The approximation for MRC then reduces to Pe_{MRC}≈c^{L} and the approximation for SC becomes:

$${Pe}_{SC} \approx {( {( \frac{( 2 L - 1 ) !!}{2} )}^{1 / L} {( \begin{matrix}2 L - 1 \\ L\end{matrix} )}^{- 1 / L} 2 c )}^{L} = {( {( \frac{( 2 L - 1 ) !!}{2 ( \begin{matrix}2 L - 1 \\ L\end{matrix} )} )}^{1 / L} 2 c )}^{L} .$$

Therefore, the SNR gain or the gap between SC and MRC is provided as:

$$10 {log}_{10} [ {( \frac{( 2 L - 1 ) !!}{2 ( \begin{matrix}2 L - 1 \\ L\end{matrix} )} )}^{1 / L} 2 ] = \frac{10}{L} {log}_{10} \frac{( 2 L - 1 ) !!}{2 ( \begin{matrix}2 L - 1 \\ L\end{matrix} )} + 3 dB .$$

Note the gap between SC and MRC here is the extra SNR needed for SC to have the same BER as MRC. In other words, MRC has a SNR gain as expressed over SC. Further more, since:

$$( 2 L - 1 ) !! = \frac{( 2 L - 1 ) !}{{2}^{L - 1} ( L - 1 ) !} , \\ \frac{( 2 L - 1 ) !!}{2 ( \begin{matrix}2 L - 1 \\ L\end{matrix} )} = \frac{( 2 L - 1 ) !}{{2}^{L - 1} ( L - 1 ) ! ⨯ 2 ( \begin{matrix}2 L - 1 \\ L\end{matrix} )} = \frac{( 2 L - 1 ) !}{{2}^{L} \frac{( L - 1 ) ! ⨯ ( 2 L - 1 ) !}{( L - 1 ) ! ⨯ L !}} = \frac{L !}{{2}^{L}}$$

can be simplified as the following:

$$\begin{matrix}10 {log}_{10} [ {( \frac{( 2 L - 1 ) !!}{2 ( \begin{matrix}2 L - 1 \\ L\end{matrix} )} )}^{1 / L} 2 ] = \frac{10}{L} {log}_{10} \frac{( 2 L - 1 ) !!}{2 ( \begin{matrix}2 L - 1 \\ L\end{matrix} )} + 3 dB \\ = \frac{10}{L} {log}_{10} \frac{L !}{{2}^{L}} + 3 dB \\ = \frac{10}{L} {log}_{10} L ! - \frac{10}{L} {log}_{10} {2}^{L} + 3 dB \\ = \frac{10}{L} {log}_{10} L !\end{matrix}$$

Therefore the SNR gain of MRC over SC is simply 10log₁₀L!/L.

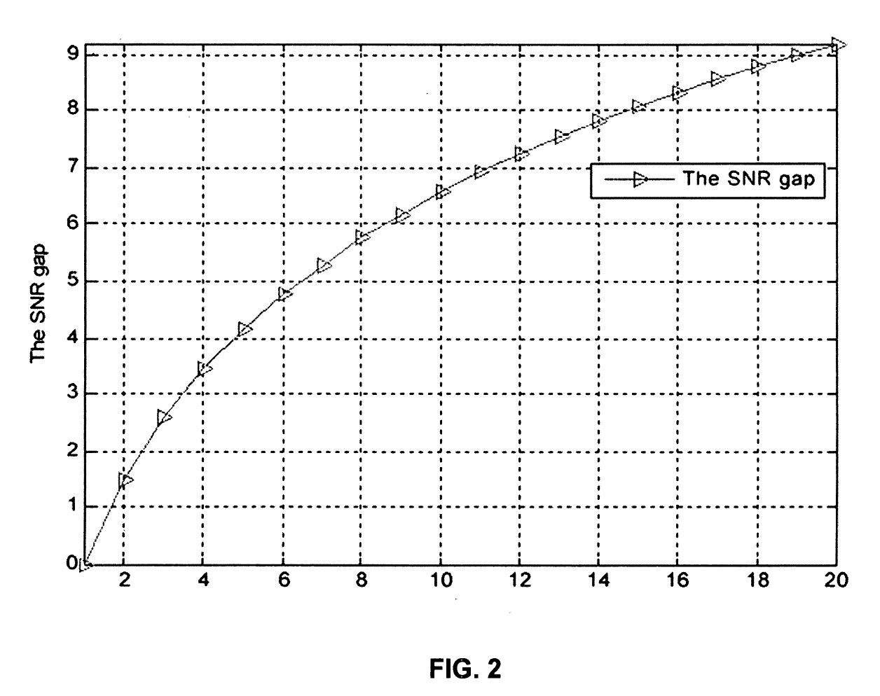

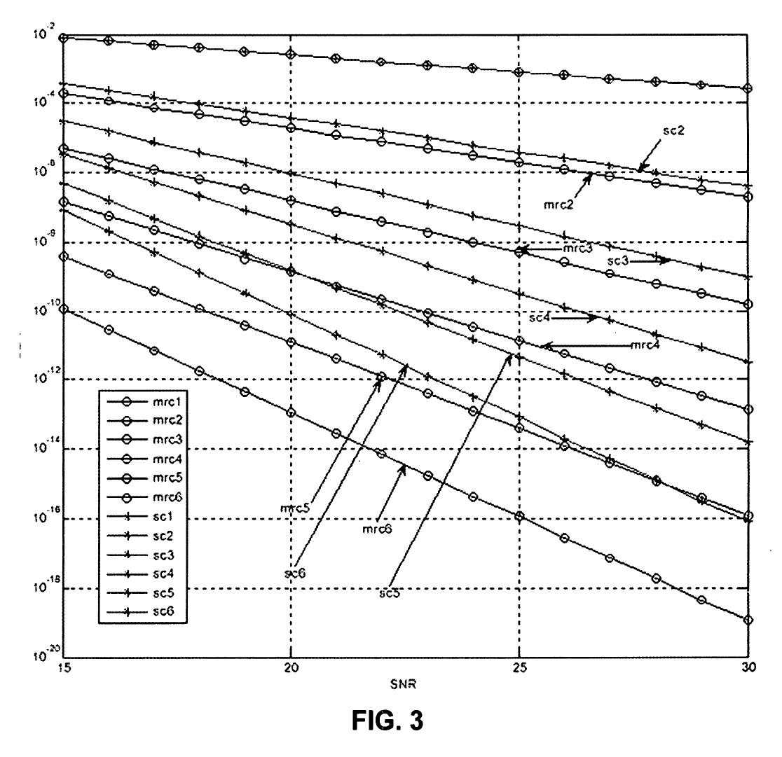

FIG. 2 plots the SNR gain of MRC over SC as a function of L. This gap can be seen to increase monotonically as L increases. To verify this result, FIG. 3 plots the BERs of both MRC and SC from their actual BER expressions as a function of L as L varying from one to six. Table 1 contains the SNR gaps between SC and MRC as L changing from one to six. Comparing the gaps in FIG. 3 and the values in Table 1, one can verify these results.

| L = 1 | L = 2 | L = 3 | L = 4 | L = 5 | L = 6 |
|---|---|---|---|---|---|
| 0 dB | 1.5 dB | 2.6 dB | 3.5 dB | 4.2 dB | 4.8 dB |

The property of the gap increases monotonically with L can also be proved theoretically as follows: Using Sterling's formula:

$$L != \sqrt{2 L π} {( \frac{L}{e} )}^{L} {ⅇ}^{\frac{θ}{12 L}} ,$$

where 0<θ<1, then

$$\begin{matrix}\frac{ⅆ}{ⅆ L} ( \frac{10}{L} {log}_{10} L ! ) = 10 \frac{ⅆ}{ⅆ L} [ \frac{1}{L} {log}_{10} \sqrt{2 L π} {( \frac{L}{e} )}^{L} {ⅇ}^{\frac{θ}{12 L}} ] \\ 10 \frac{ⅆ}{ⅆ L} [ \frac{1}{L} {log}_{10} \sqrt{2 L π} + {log}_{10} ( \frac{L}{e} ) + \frac{θ}{12} {log}_{10} e ] \\ 10 [ \frac{- 1}{{L}^{2}} {log}_{10} \sqrt{2 L π} + \frac{1}{L} \frac{1}{\sqrt{L}} {log}_{10} e + \frac{e}{L} {log}_{10} e ] \\ = 10 [ \frac{- 1}{2 {L}^{2}} {log}_{10} L - \frac{1}{{L}^{2}} {log}_{10} \sqrt{2 π} + \\ \frac{1}{L} \frac{1}{\sqrt{L}} {log}_{10} e + \frac{e}{L} {log}_{10} e ] \\ = 10 [ ( \frac{e}{L} {log}_{10} e - \frac{1}{2 {L}^{2}} {log}_{10} L \frac{1}{L} ) + \\ ( \frac{1}{\sqrt{L}} {log}_{10} e - \frac{1}{{L}^{2}} {log}_{10} \sqrt{2 π} ) ]\end{matrix}$$

since

$$\frac{e}{L} {log}_{10} e > \frac{e {log}_{10} e}{{L}^{2}} {log}_{10} L > \frac{1}{2 {L}^{2}} {log}_{10} L ,$$

where the first inequality comes from the fact that

$$\frac{{log}_{10} L}{L} < 1$$

and the second inequality comes from the fact that elog₁₀e>½, the first parenthesis is greater than zero. Also since

$$\frac{1}{L} \frac{1}{\sqrt{L}} {log}_{10} e > \frac{1}{L} \frac{\sqrt{L}}{\sqrt{L} \sqrt{L}} {log}_{10} e > \frac{1}{{L}^{2}} {log}_{10} \sqrt{2 π} ,$$

where the second inequality comes from the fact that \sqrt{L}log₁₀e>log₁₀\sqrt{2π}, the second parenthesis is also greater than zero. Therefore,

$$\frac{ⅆ}{ⅆ L} ( \frac{10}{L} {log}_{10} L ! ) > 0$$

And also as L increases, using Sterling's formula again for a large L,

$$L != \sqrt{2 L π} {( \frac{L}{e} )}^{L} ,$$

then:

$$\begin{matrix}\frac{10}{L} {log}_{10} L != 10 \frac{ⅆ}{ⅆ L} [ \frac{1}{L} {log}_{10} \sqrt{2 L π} + {log}_{10} ( \frac{L}{e} ) ] \\ = 10 [ \frac{- 1}{{L}^{2}} {log}_{10} \sqrt{2 L π} + \frac{1}{L} \frac{1}{\sqrt{L}} {log}_{10} e + \frac{e}{L} {log}_{10} e ]\end{matrix} Since {lim}_{L \to ∞} [ \frac{1}{L} {log}_{10} \sqrt{2 L π} + {log}_{10} ( \frac{L}{e} ) ] = ∞$$

The SNR gain of MRC over SC goes to infinity as the number of diversity branches goes to infinity. This result intuitively makes sense because performance loss of selecting only one, even though it is the largest one, increases compared to selecting all of them.

The term 10log₁₀L!/L may be used to describe the SNR gap between MRC and SC combing schemes in the design of communications systems that may employ these diversity combining methods. The knowledge of a more accurate expression for the SNR gap allows system designers to design systems that can trade-off between complexity (or cost) and quality.

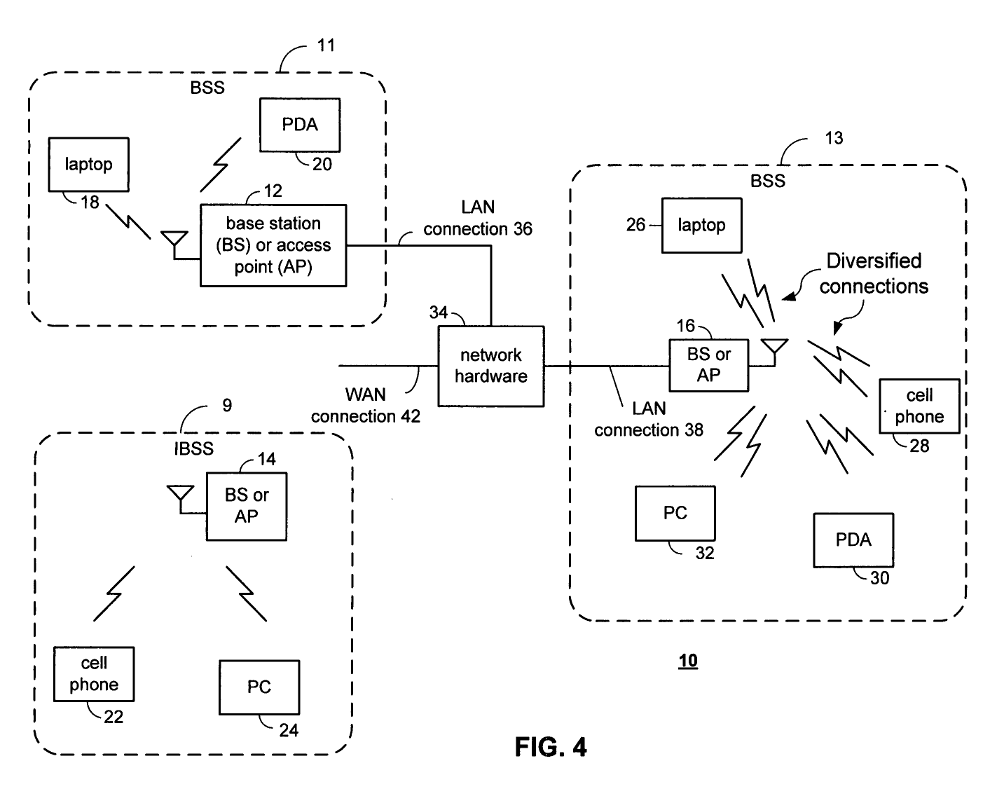

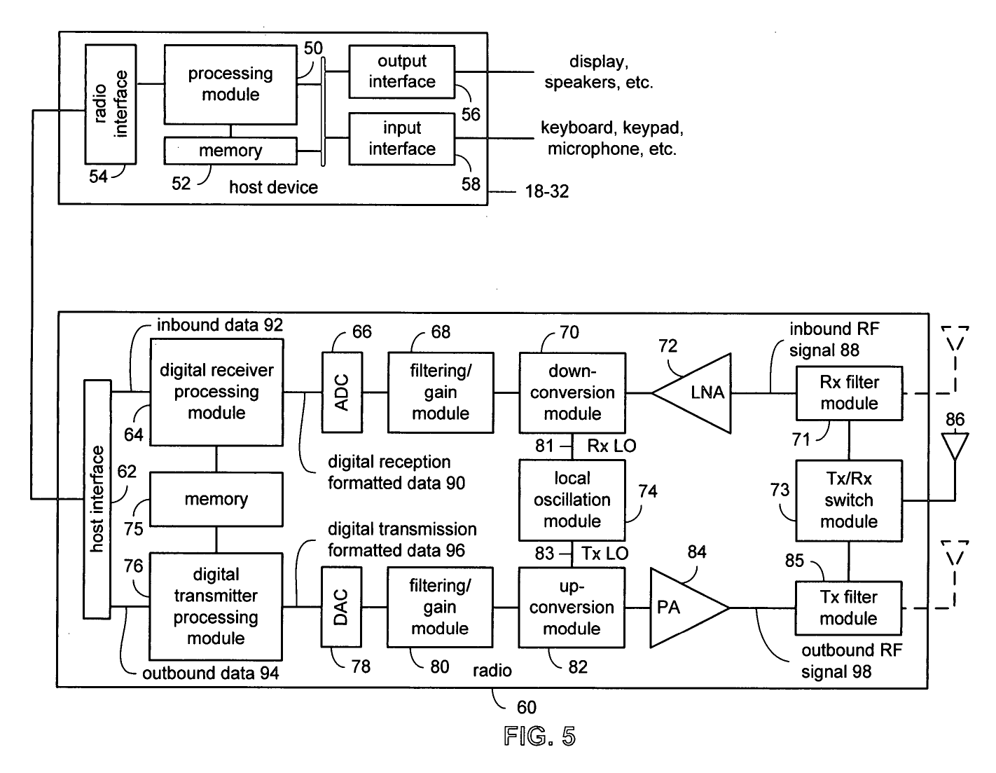

FIG. 4 is a schematic block diagram illustrating such a communication system 10 that includes a plurality of base stations and/or access points 12-16, a plurality of wireless communication devices 18-32 and a network hardware component 34. The wireless communication devices 18-32 may be laptop host computers 18 and 26, personal digital assistant hosts 20 and 30, personal computer hosts 24 and 32 and/or cellular telephone hosts 22 and 28. Each of these devices may use diversified connections with to communicate with associated base stations and access points. The details of one typical wireless communication devices will be described in greater detail with reference to FIG. 5.

The base stations or access points 12-16 are operably coupled to the network hardware 34 via local area network connections 36, 38 and 40. The network hardware 34, which may be a router, switch, bridge, modem, system controller, et cetera, provides a wide area network connection 42 for the communication system 10. Each of the base stations or access points 12-16 has an associated antenna or antenna array to communicate with the wireless communication devices in its area. These communications may be subject to multipath fading. Methods of addressing multipath fading will be discussed in further detail with reference to FIG. 3 and following. The methods presented to address multipath fading within this discussion may be applied to both wireless and wire-line communications. These methods apply to combining situation whenever the diversity replicas exist. Furthermore, these methods do not require that these diversity replicas/branches necessarily come from multipath communications. These methods are applicable to single path with retransmissions or multiple receiving antennas, or other like situations known to those having skill in the art.

Typically, the wireless communication devices register with a particular base station or access point 12-14 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio. The radio includes a highly linear amplifier and/or programmable multi-stage amplifier as disclosed herein to enhance performance, reduce costs, reduce size, and/or enhance broadband applications.

Furthermore, both direct and indirect communications may experience multipath fading. multipath fading is the deflection of a wireless communications signals off obstacles that can cause interference during reception. Multipath fading occurs when a wireless communications signal is received by an antenna and later the same signal is received again, reflected from an obstacle. Under certain conditions, two or more of the signals can interfere with each other and create “fading” (a loss of signal) in the communications link. As the amount of data contained within wireless communications increase and the power of the transmitted signal is reduced, the techniques chosen to combat the multipath fading can vary. The diversity combining scheme selected to address this problem can be selected as the communication system components are being designed. Knowledge of a more accurate term for the SNR gap, wherein the SNR gap may be described by the expression 10log₁₀L!/L, allows the overall communication system to be designed with a greater understanding of the expected performance. This knowledge may also be applied to existing systems to determine what steps are taken to address the multipath fading.

FIG. 5 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component. Space and time diversity may be associated with the communications received by these wireless communication devices. Received signals, at antenna 86 may be separated in time due to retransmission or space due to varied propagation paths. This type of diversity is addressed by diversity combining schemes such as those provided by MRC or SC. Since MRC involves more complexity when compared to SC and utilizes all diversity branches, MRC may result in better performance when compared with SC. This improved performance derives from an SNR gain that MRC provides over SC. Knowing this gain may help assess whole system performance and allow system designers to design systems that can trade-off between complexity (or cost) and quality. The SNR gap between the MRC and SC has often been approximated as 10log₁₀L. The present invention teaches that this SNR gap is more accurately expressed by the expression 10log₁₀L!/L. This corrects for many previously approximated inaccuracies when L is not large.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, et cetera such that the received data may be displayed. The radio interface 54 also provides data from the processing module 50 to the radio 60. The processing module 50 may receive the outbound data from an input device such as a keyboard, keypad, microphone, et cetera via the input interface 58 or generate the data itself. For data received via the input interface 58, the processing module 50 may perform a corresponding host function on the data and/or route it to the radio 60 via the radio interface 54.

Radio 60 includes a host interface 62, digital receiver processing module 64, an analog-to-digital converter 66, a filtering/gain module 68, an IF mixing down conversion stage 70, a receiver filter 71, a low noise amplifier 72, a transmitter/receiver switch 73, a local oscillation module 74, memory 75, a digital transmitter processing module 76, a digital-to-analog converter 78, a filtering/gain module 80, an IF mixing up conversion stage 82, a power amplifier 84, a transmitter filter module 85, and an antenna 86. The antenna 86 may be a single antenna that is shared by the transmit and receive paths as regulated by the Tx/Rx switch 73, or may include separate antennas for the transmit path and receive path. The antenna implementation will depend on the particular standard to which the wireless communication device is compliant.

The digital receiver processing module 64 and the digital transmitter processing module 76, in combination with operational instructions stored in memory 75, execute receiver functions and transmitter functions, respectively. The receiver functions include, but are not limited to, diversity techniques, intermediate frequency to baseband conversion, demodulation, constellation demapping, decoding, and/or descrambling. The transmitter functions include, but are not limited to, scrambling, encoding, constellation mapping, modulation, and/or digital baseband to IF conversion. The receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 64 and/or 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The host interface 62 routes the outbound data 94 to the digital transmitter processing module 76, which processes the outbound data 94 in accordance with a particular wireless communication standard (e.g., IEEE 802.11 Bluetooth, et cetera) to produce digital transmission formatted data 96. The digital transmission formatted data 96 will be a digital base-band signal or a digital low IF signal, where the low IF typically will be in the frequency range of one hundred kilohertz to a few megahertz.

The digital-to-analog converter 78 converts the digital transmission formatted data 96 from the digital domain to the analog domain. The filtering/gain module 80 filters and/or adjusts the gain of the analog signal prior to providing it to the IF mixing stage 82. The IF mixing stage 82 converts the analog baseband or low IF signal into an RF signal based on a transmitter local oscillation 83 provided by local oscillation module 74. The power amplifier 84 amplifies the RF signal to produce outbound RF signal 98, which is filtered by the transmitter filter module 85. The antenna 86 transmits the outbound RF signal 98 to a targeted device such as a base station, an access point and/or another wireless communication device.

The radio 60 also receives an inbound RF signal 88 via the antenna 86, which was transmitted by a base station, an access point, or another wireless communication device. The antenna 86 provides the inbound RF signal 88 to the receiver filter module 71 via the Tx/Rx switch 73, where the Rx filter 71 bandpass filters the inbound RF signal 88. The Rx filter 71 provides the filtered RF signal to low noise amplifier 72, which amplifies the signal 88 to produce an amplified inbound RF signal. The low noise amplifier 72 provides the amplified inbound RF signal to the IF mixing module 70, which directly converts the amplified inbound RF signal into an inbound low IF signal or baseband signal based on a receiver local oscillation 81 provided by local oscillation module 74. The down conversion module 70 provides the inbound low IF signal or baseband signal to the filtering/gain module 68. The filtering/gain module 68 filters and/or gains the inbound low IF signal or the inbound baseband signal to produce a filtered inbound signal.

The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92 in accordance with the particular wireless communication standard being implemented by radio 60. The host interface 62 provides the recaptured inbound data 92 to the host device 18-32 via the radio interface 54.

As one of average skill in the art will appreciate, the wireless communication device of FIG. 5 may be implemented using one or more integrated circuits. For example, the host device may be implemented on one integrated circuit, the digital receiver processing module 64, the digital transmitter processing module 76 and memory 75 may be implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device and the digital receiver and transmitter processing modules 64 and 76 may be a common processing device implemented on a single integrated circuit. Further, the memory 52 and memory 75 may be implemented on a single integrated circuit and/or on the same integrated circuit as the common processing modules of processing module 50 and the digital receiver and transmitter processing module 64 and 76.

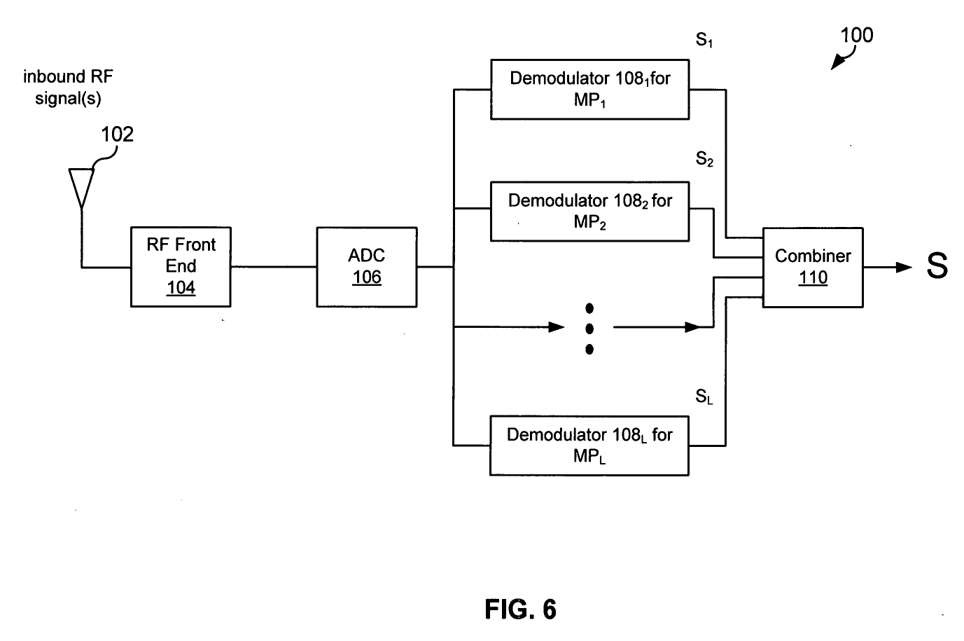

FIG. 6 is a schematic block diagram illustrating one application of diversity combining within a RAKE receiver. Within RAKE receiver 100 RF signals are received via an antenna 102 and processed using receiver(s) 104. The received signals may then be converted to digital signals with ADC 106. RAKE receiver 100 may be employed within a CDMA communication system where diversity combining plays a critical part. Although RAKE receiver 100 is discussed with respect to wireless communications. Embodiments of the present invention may be applicable to any scenario where multipath fading combining is utilized. This may occur in both wireless and wireline communications and it may deal with combining situations where replicas of the incoming signal are received with multiple antennas or retransmissions or signals received in singlepath or multipath environments. Additionally, other scenarios known to those skilled in the art may exist where these techniques may be applied.

In a typical multipath scenario, Signal S₁ is processed by a demodulator 108₁ for the particular multipath pathway. Similarly, signals S₂ through S_{L} are processed by demodulator(s) 108₂ through 108_{L}. Combiner 110 may use a combination of logic or arithmetic functions to select and combine these signals to produce output signal S that has both diversity gain and SNR gain. Typically, signal S₁ provides a better approximation of signal S than any of the other signals S₂ through S_{L}. However, combining these signals properly can result in improved SNR and receiver performance.

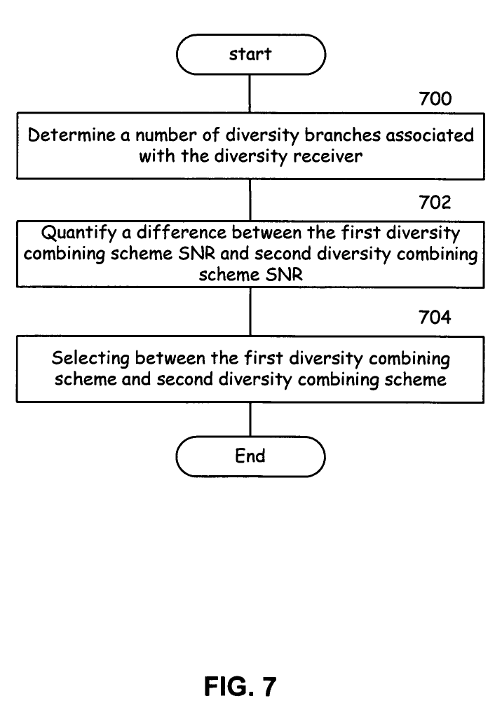

FIG. 7 provides a logic flow diagram that provides a method for quantifying an SNR gap for a given bit error rate for two diversity combining schemes. The BER is a function of the inverse of the SNR to the L^{th} order. This allows the quantification of a difference between a first diversity combining scheme SNR may be determined in Step 702. As described above the first diversity combining scheme may be a selection combining scheme while the second diversity combining scheme may be a maximum ratio combining scheme. This may be done during the design of the receiver to determine the type of diversity combining to be employed within the receiver. In step 704, a potential combining scheme is selected for the design based on balancing system performance requirements with required complexity.

Another embodiment may utilize knowledge of the SNR, SNR gap, and a given BER to select a diversity combining scheme that may be used to process a multi-path communication. This may be done during the design of the receiver, wherein the receiver is optimized to implement a particular diversity combining scheme.

Alternatively, a diversity receiver, having a number of diversity branches, will support wireless communications at a maximum BER. (i.e., the diversity receiver may be unable to process the communications if the BER exceeds this maximum BER) The observed (actual) SNR when compared with diversity combining scheme SNRs at the maximum BER, allows the selection of an appropriate diversity combining scheme. The diversity receiver, when operable to support multiple diversity combining schemes, may be reconfigurable to select and support a diversity combining scheme where the actual SNR and the diversity combining scheme SNR at the maximum BER compare favorably.

Thus, the diversity receiver may select the employed combining scheme based on the actual SNR associated with the received multi-path wireless communications. This selection may be based in part on reducing processing loads on the wireless terminal's internal processors by choosing a less computationally intensive combining scheme when supported by the SNR. For example, a selection combining scheme may be less computationally intensive than a maximal ratio combining scheme. Thus to reduce the processing load on the internal processors, the selection combining scheme may be utilized when the actual SNR supports selection combining.

These wireless communications may conform to an otherwise wireless communication standard or variant such as Code Division Multiple Access (CDMA), Global System for Mobile Communications (GSM), Time Division Multiple Access (TDMA), and Orthogonal Frequency Division Multiplexing (OFDM), and other like communication standards known to those having skill in the art.

This method may be modified to select the diversity combining scheme by first determining the acceptable BER that the wireless communications may support. Then determining the SNR associated with the multi-path communication. The number of diversity branches may be determined by the receiver in the multi-path communications. A BER may be determined for each diversity combining scheme where this BER is a function of the inverse of the SNR to an L^{th} order. The permissible BER may be compared to the individual combining scheme BERs and then the least computationally intensive combining scheme may be selected that has an acceptable BER.

As stated previously the wireless terminal discussed in detail with respect to FIG. 5 may implement a diversity scheme based on design considerations for what the multi-path communication SNR received will be, or select a diversity combining scheme to process received multi-path communications.

In summary, the present invention provides a method of quantifying a SNR gap for a BER between diversity combining schemes that are operable to process multi-path wireless communications, wherein the combining schemes are operable to be used in the processing of multi-path wireless communications. Embodiments of the present invention define an SNR gap between the MRC and SC combining scheme as 10log₁₀L!/L. This corrects for many previously approximated inaccuracies when L (the number of diversity branches) is not large.

This process involves determining the number of diversity branches associated with the multi-path wireless communication and the receiver used to process the multi-path wireless communication. A first diversity combining scheme SNR and second diversity combining scheme SNR may be determined for a given BER such as the maximum BER operable to support wireless communications received by a diversity receiver. This maximum BER may be a function of the inverse of the SNR to the L^{th} order. Then the difference between the combining scheme SNRs may be quantified 10log₁₀L!/L.

Since MRC involves more complexity when compared to SC and utilizes all diversity branches, MRC may result in better performance when compared with SC. This improved performance derives from an SNR gain that MRC provides over SC. Knowing this gain helps to assess whole system performance and allow system designers to balance system complexity (or cost) and overall performance.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions and alterations can be made hereto without departing from the spirit and scope of the invention as described by the appended claims.

What is claimed is:

1. A method for quantifying a signal to noise ratio (SNR) gap for an arbitrary number of diversity branches between at least two diversity combining schemes that are operable to process a multipath wireless communication, the method comprising:
determining a number of diversity branches, L, associated with the multipath wireless communication;
determining a first diversity combining scheme SNR associated with the number of diversity branches;
determining a second diversity combining scheme SNR associated with the number of diversity branches; and
quantifying a difference between the first diversity combining scheme SNR and second diversity combining scheme SNR.

2. The method of claim 1, wherein:
the first diversity combining scheme comprises selection combining (SC); and
the second diversity combining scheme comprises maximal ratio combining (MRC).

3. The method of claim 2, wherein:
an MRC bit error rate (BER)
$$BER ( {Pe}_{mrc} ) \approx ( \begin{matrix}2 L - 1 \\ L\end{matrix} ) {( \frac{1}{4} c )}^{L} ;$$
and
an
$$SC BER ( {Pe}_{sc} ) \approx \frac{( 2 L - 1 ) !!}{{2}^{L + 1}} {c}^{L} , wherein c = \frac{1}{Γ} ,$$
and Γ is an average SNR per diversity branch.

4. The method of claim 3, wherein the difference between the first diversity combining scheme SNR and second diversity combining scheme SNR for the number of diversity branches is about
$$\frac{10}{L} {log}_{10} L ! .$$

5. The method of claim 4, wherein the multipath wireless communication conforms to a wireless communication standard or variant of the wireless communication standard selected from the group consisting of:
Code Division Multiple Access (CDMA);
Global System for Mobile communications (GSM);
Time Division Multiple Access (TDMA); and
Orthogonal Frequency Division Multiplexing (OFDM).

6. The method of claim 1, further comprising:
determining an actual SNR associated with the multipath wireless communication, and wherein a given BER is a maximum BER operable to support wireless communications;
comparing the actual SNR with the first diversity combining scheme SNR associated with the given BER;
comparing the actual SNR with the second diversity combining scheme SNR associated with the given BER;
selecting the first diversity combining scheme to process the multipath wireless communication when the first diversity combining scheme SNR compares favorable to the actual SNR; and
selecting the second diversity combining scheme to process the multipath communication when the first diversity combining scheme SNR compares unfavorable to the actual SNR.

7. A method of selecting a diversity combining scheme used to process a multipath communication, comprising:
determining an acceptable bit error rate (BER);
determining a signal to noise ratio (SNR) associated with the multipath communication;
determining a number of diversity branches, L, associated with the multipath communication;
determining a first diversity combining scheme BER, wherein the first diversity combining scheme BER is a function of an inverse of the SNR to an L^{th} order;
determining a second diversity combining scheme BER, wherein the second diversity combining scheme BER is a function of an inverse of the SNR to an L^{th} order;
comparing the acceptable BER to the first diversity combining scheme BER and second diversity combining scheme BER;
selecting the first diversity combining scheme to process the multipath communication when the first diversity combining scheme BER compares favorable to the acceptable BER; and
selecting the second diversity combining scheme to process the multipath communication when the first diversity combining scheme BER compares unfavorable to the acceptable BER.

8. The method of claim 7, wherein:
the first diversity combining scheme comprises selection combining (SC); and
the second diversity combining scheme comprises maximal ratio combining (MRC).

9. The method of claim 8, wherein:
the
$$MRC BER ( {Pe}_{mrc} ) \approx ( \begin{matrix}2 L - 1 \\ L\end{matrix} ) {( \frac{1}{4} c )}^{L} ;$$
and
the
$$SC BER ( {Pe}_{sc} ) \approx \frac{( 2 L - 1 ) !!}{{2}^{L + 1}} {c}^{L} , wherein c = \frac{1}{Γ} ,$$
and Γ is an average SNR per diversity branch.

10. The method of claim 9, wherein the difference between the first diversity combining scheme SNR and second diversity combining scheme SNR for the given BER is about
$$\frac{10}{L} {log}_{10} L ! .$$

11. The method of claim 4, wherein the multipath wireless communication conforms to a wireless communication standard or variant of the wireless communication standard selected from the group consisting of:
Code Division Multiple Access (CDMA);
Global System for Mobile communications (GSM);
Time Division Multiple Access (TDMA); and
Orthogonal Frequency Division Multiplexing (OFDM).

12. A method of processing a multipath wireless communication, comprising:
receiving the multipath wireless communication, wherein a number of diversity branches, L, are associated with the received multipath wireless communication;
determining a signal to noise ratio (SNR) associated with the received multipath wireless communication;
determining a first diversity combining scheme BER, wherein the first diversity combining scheme BER is a function of an inverse of the SNR to an L^{th} order;
determining a second diversity combining scheme BER, wherein the second diversity combining scheme BER is a function of an inverse of the SNR to an L^{th} order;
comparing an acceptable BER to the first diversity combining scheme BER and second diversity combining scheme BER;
selecting the first diversity combining scheme to process the multipath communication when the first diversity combining scheme BER compares favorable to the acceptable BER;
selecting the second diversity combining scheme to process the multipath communication when the first diversity combining scheme BER compares unfavorable to the acceptable BER;
applying the selected diversity combining scheme to the received multipath communication to produce a combined signal;
down converting the combined signal to produce a baseband signal; and
processing the baseband signal to produce a data block.

13. The method of claim 12, wherein:
the first diversity scheme comprises selection combining (SC); and
the second diversity scheme comprises maximal ratio combining (MRC).

14. The method of claim 13, wherein:
the
$$MRC BER ( {Pe}_{mrc} ) \approx ( \begin{matrix}2 L - 1 \\ L\end{matrix} ) {( \frac{1}{4} c )}^{L} ;$$
and
the
$$SC BER ( {Pe}_{sc} ) \approx \frac{( 2 L - 1 ) !!}{{2}^{L + 1}} {c}^{L} , wherein c = \frac{1}{Γ} ,$$
and Γ is an average SNR per diversity branch.

15. The method of claim 14, wherein the difference between the first diversity scheme SNR and second diversity scheme SNR for the given BER is about
$$\frac{10}{L} {log}_{10} L ! .$$

16. The method of claim 15, wherein the multipath wireless communication conforms to a wireless communication standard or variant of the wireless communication standard selected from the group consisting of:
Code Division Multiple Access (CDMA);
Global System for Mobile communications (GSM);
Time Division Multiple Access (TDMA); and
Orthogonal Frequency Division Multiplexing (OFDM).

17. A wireless terminal operable to select a diversity combining scheme to process a received multipath communication, comprising:
a Radio Frequency (RF) front end, wherein, the RF front end is operable to:
determine a signal to noise ratio (SNR) associated with the multipath communication;
determine a number of diversity branches, L, associated with the multipath communication;
determine a first diversity scheme BER, wherein the first diversity scheme BER is a function of an inverse of the SNR to an L^{th} order;
determine a second diversity scheme BER, wherein the second diversity scheme BER is a function of an inverse of the SNR to an L^{th} order;
compare a required BER to the first diversity scheme BER and second diversity scheme BER;
select the first diversity scheme to process the multipath communication when the first diversity scheme BER compares favorable to the required BER;
select the second diversity scheme to process the multipath communication when the first diversity scheme BER compares unfavorable to the required BER;
apply the selected diversity combining scheme to the multipath communication to produce a combined signal;
down convert the combined signal to produce a baseband signal; and
a baseband processor communicatively coupled to the RF front end, wherein the baseband processor is operable to process the baseband signal to produce a data block.

18. The wireless terminal of claim 17, wherein the RF front end further comprises a rake receiver, and wherein the number of diversity branches, L, is determined by a number of fingers within the rake receiver.

19. The wireless terminal of claim 17, wherein the first diversity scheme BER compares favorably to the required BER corresponds to the first diversity scheme BER not exceeding a threshold BER value, and wherein the first diversity scheme BER compares unfavorably to the required BER corresponds to the first diversity scheme BER exceeding a threshold BER value.

20. The wireless terminal of claim 19, wherein the threshold BER value is based on a Coding Scheme of the multipath communication.

21. The wireless terminal of claim 20, wherein:
the first diversity scheme comprises selection combining (SC); and
the second diversity scheme comprises maximal ratio combining (MRC).

22. The wireless terminal of claim 21, wherein:
the
$$MRC BER ( {Pe}_{mrc} ) \approx ( \begin{matrix}2 L - 1 \\ L\end{matrix} ) {( \frac{1}{4} c )}^{L} ;$$
and the
$$SC BER ( {Pe}_{sc} ) \approx \frac{( 2 L - 1 ) !!}{{2}^{L + 1}} {c}^{L} , \\ wherein c = \frac{1}{Γ} ,$$
and Γ is an average SNR per diversity branch.

23. The wireless terminal of claim 22, wherein the difference between the first diversity scheme SNR and second diversity scheme SNR for the given BER is about
$$\frac{10}{L} {log}_{10} L ! .$$

24. The wireless terminal of claim 23, wherein the multipath wireless communication conforms to a wireless communication standard or variant of the wireless communication standard selected from the group consisting of:
Code Division Multiple Access (CDMA);
Global System for Mobile communications (GSM);
Time Division Multiple Access (TDMA); and
Orthogonal Frequency Division Multiplexing (OFDM).
